(19) United States
(12) Patent Application Publication
(10) Pub. No.: US 2026/0320965 A1
(43) Pub. Date: Oct. 15, 2026

(54) SEGMENTATION OF ANATOMICAL STRUCTURES IN MEDICAL VOLUMETRIC IMAGING DATASETS USING TRANSFORMER

(71) Applicant: Siemens Healthineers AG, Forchheim (DE)

(72) Inventors: Xueqi Guo, Malvern, PA (US); Halid Yerebakan, Carmel, IN (US); Yoshihisa Shinagawa, Downingtown, PA (US); Kritika Iyer, Conshohocken, PA (US); Gerardo Hermosillo Valadez, West Chester, PA (US)

(21) Appl. No.: 19/554,036

(22) Filed: Mar. 2, 2026

(30) Foreign Application Priority Data
Apr. 10, 2025 (DE) 10 2025 114 214.9

(51) Int. Cl. G06V 10/26; G06V 10/774; G06V 10/82

(52) U.S. Cl. CPC G06V 10/267; G06V 10/774; G06V 10/82; G06V 2201/031

(57) ABSTRACT

A framework for segmentation of volumetric imaging datasets. A segmentation dataset locating one or more anatomical features in a medical volumetric imaging dataset of a patient is obtained by using at least one trained function. The trained function may comprise a residual neural network processing first feature vectors encoding features of the medical volumetric imaging dataset and outputting second feature vectors. The trained function may further comprise a transformer network processing third feature vectors obtained by combining the second feature vectors with positional encodings and generating contextualized fourth feature vectors. The trained function may further comprise a decoder network for generating segmentation datasets based on the fourth feature vectors.

### CROSS-REFERENCE TO RELATED APPLICATION

This application claims the benefit of priority from DE Application No. 10 2025 114 214.9, filed on Apr. 10, 2025, the contents of which are incorporated by reference.

### TECHNICAL FIELD

Various examples of the disclosure pertain to generating segmentation datasets locating one or more anatomical features in a medical volumetric imaging dataset of a patient. Various examples of the disclosure specifically pertain to using a machine-learning model as trained function for generating segmentation datasets.

### BACKGROUND

Multi-organ segmentation of volumetric medical imaging datasets is employed in various clinical processes. However, the time and memory consumption of segmenting the entire three-dimensional volume voxel-by-voxel using, e.g., machine-learning (ML) models such as deep neural networks (DNNs) can be significant.

In the state-of-the-art, various DNN architectures have been implemented for multi-organ segmentation. However, voxel-level computation in leveraging these DNN is generally slow. For instance, the efficiency of transformer-based methods has been reported to reach a runtime speed of 60 seconds on a graphics processing unit (GPU). Real-time-level computational efficiency has not yet been achieved, especially on central processing unit (CPU)-only hardware.

Further, the state-of-the-art classifier-based fast coarse segmentation and refinement methods using DNNs can be implemented on conventional on-premise personal computer (PC) hardware including a CPU. However, the edge refinement of a respective segmentation mask was reported to have an average runtime of 9.51 seconds. Although the system is independent of GPU usage, it remains too slow for near-real-time applications, hindering efficiency for radiologists.

Various attempts use sparse sampling and residual DNNs for fast fine segmentation. However, using residual DNNs alone cannot fully capture the spatial dependencies among the descriptors, resulting in unclear edges. Thus, the spatial dependencies and anatomical features may not be fully utilized and analyzed by using only residual DNNs.

As will be appreciated from the above, various techniques reported in the state-of-the-art either suffer from limited accuracy of the segmentation data and/or suffer from increased requirement for computational resources hindering real-time and near-real-time applications.

### SUMMARY

A framework for using at least one trained function to obtain a segmentation dataset locating one or more anatomical features in a medical volumetric imaging dataset of a patient is disclosed. The trained function may comprise a residual neural network processing first feature vectors encoding features of the medical volumetric imaging dataset and outputting second feature vectors. The trained function may further comprise a transformer network processing third feature vectors obtained by combining the second feature vectors with positional encodings and generating contextualized fourth feature vectors. The trained function may further comprise a decoder network for generating segmentation datasets based on the fourth feature vectors.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 schematically illustrates a system including a medical imaging system and a computing device according to various examples.

FIG. 2 schematically illustrates a processing pipeline according to various examples.

FIG. 3 illustrates an image including a query location according to various examples.

FIG. 4 illustrates sparse local descriptor sampling grids according to various examples.

FIG. 5 illustrates a segmentation reconstruction according to various examples.

FIG. 6 illustrates segmentation results according to various examples.

FIG. 7 is a flowchart of a method according to various examples.

FIG. 8 is a flowchart of a method according to various examples.

### DETAILED DESCRIPTION

In the following description, numerous specific details are set forth such as examples of specific components, devices, methods, etc., in order to provide a thorough understanding of implementations of the present framework. It will be apparent, however, to one skilled in the art that these specific details need not be employed to practice implementations of the present framework. In other instances, well-known materials or methods have not been described in detail in order to avoid unnecessarily obscuring implementations of the present framework. While the present framework is susceptible to various modifications and alternative forms, specific embodiments thereof are shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention. Furthermore, for ease of understanding, certain method steps are delineated as separate steps; however, these separately delineated steps should not be construed as necessarily order dependent in their performance. Independent of the grammatical term usage, individuals with male, female or other gender identities are included within the term.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, implementations of the present framework are not described with reference to any particular programming language. It will be appreciated that a variety of programming languages may be used. Independent of the grammatical term usage, individuals with male, female or other gender identities are included within the term.

There is a need for advanced techniques to provide a segmentation dataset for a medical volumetric imaging dataset overcoming at least some of the above-identified restrictions and drawbacks of the prior art. This need is met by the features of the independent claim(s). The features of the dependent claims define embodiments.

According to various examples, a trained function is employed for providing segmentation data for medical volumetric imaging data set. The trained function may also be referred to as an ML model. According to various examples, a specific architecture is used for the ML model.

A computer-implemented method for using at least one trained function to obtain a segmentation dataset locating one or more anatomical features in a medical volumetric imaging dataset of a patient is disclosed. The at least one trained function comprises a residual neural network processing first feature vectors encoding features of the medical volumetric imaging dataset and outputting second feature vectors. The at least one trained function further comprises a transformer network processing third feature vectors obtained by combining the second feature vectors with positional encodings and generating contextualized fourth feature vectors. The at least one trained function further comprises a decoder network for generating segmentation datasets based on the fourth feature vectors.

The one or more anatomical features may be, for example, a lung or any other organ. The anatomical features can comprise any detailed information related to the human anatomy.

The medical volumetric imaging dataset of the patient can be obtained by a computed tomography scan, magnetic resonance imaging, X-ray imaging, ultrasound imaging, Positron Emission Tomography imaging, etc. The medical volumetric imaging dataset may capture a 3D field-of-view (FOV), i.e., depict the patient's anatomy in a certain volume. The medical volumetric imaging dataset may be made up of a number of slices, for example, two-dimensional (2D) slice images. The 2D slice images may be assembled to form the medical volumetric imaging dataset. The medical volumetric imaging dataset may comprise an array of voxels.

A voxel is a 3D counterpart to a pixel. It represents a value on a regular grid in the 3D space. Voxels are frequently used in the visualization and analysis of medical and scientific data. The position of a voxel can be inferred based upon its position relative to other voxels. The voxels can be arranged on a 3D grid. The voxel may be representative of intensity, absorption or other parameters as a function of a 3D position.

The segmentation data sets can take various forms. For instance, segmentation masks may be output by the trained function. A segmentation mask for a medical volumetric imaging dataset is a 3D array having an array entry for each voxel of the medical volumetric imaging dataset; each position of the array encodes the class to which the respective voxel belongs. This makes it possible to detect objects with voxel accuracy.

A residual neural network (ResNet) is a DNN architecture. The ResNet includes residual connections or skip-connections that perform an identity mapping to connect the input to its output. Residual connections allow the ResNet to skip layers. The residual connections make it possible to train DNNs having a large number of layers, because the problem of the vanishing gradients is mitigated. The vanishing gradient problem is the problem of diverging gradients when training neural networks with backpropagation. Backpropagation uses the gradient descent method to adjust the weights of the neural network. During backpropagation, the residual connections do not suffer from the vanishing gradient because their derivatives are just the identity. Blocks with a residual connection are called residual blocks. A typical architecture of a ResNet includes several residual blocks. For example, a ResNet block can include a subnetwork containing a convolution, a batch normalization, an activation function, another convolution, another batch normalization, a residual connection that is added to the output of the subnetwork, and an activation function applied after the residual connection, where the input and output dimensions are equal. Another realization of a ResNet block may include three sequential convolutional layers and a residual connection. Other variations of a residual block are also possible. Using the ResNet for encoding the features of the medical volumetric imaging data set helps to provide respective feature vectors that accurately capture the relevant features, since the number of layers can be comparatively high.

A transformer network is a DNN architecture based on an attention mechanism. In general, the transformer network takes an input sequence of tokens and predicts the next token in the output sequence. In the present case, a sequence of feature vectors, combined with the positional encodings, as obtained from the ResNet is used as the sequence of token sequence. Positional encodings may take various forms, such as sinusoidal functions or learned embeddings. The positional encodings enable the transformer network to understand the relative positions of voxels or features within the medical volumetric imaging dataset. The attention mechanism determines the relative importance of each component in a sequence relative to the other components in that sequence. In a sense, the attention mechanism allows the model to move information from one embedded vector to another. A transformer can run through an attention mechanism several times in parallel. Also, a transformer can contain a series of encoder and decoder layers. The transformer layers enable the network to add contextualized information and to capture relationships and dependencies between all parts of the input sequence.

According to examples, a volumetric imaging dataset of a patient's lung obtained by a computed tomography scan or by magnetic resonance imaging or by any other medical imaging technique. The dataset can be embedded into the first feature vectors. The ResNet then processes the first feature vectors encoding features of the medical volumetric imaging dataset and outputting second feature vectors. ResNet, for example, fuses and extracts meaningful information from the second feature vectors and generates third feature vectors as the input token of the transformer network. The second feature vectors may have a higher imaging resolution than the first feature vectors. Third feature vectors are obtained by encoding positional information to the second feature vectors. The third feature vectors are processed by the transformer network of the trained function to generate contextualized fourth feature vectors. The transformer encoder contains, for example, an architecture of multi-head self-attention and feed forward network that captures the contextual information among the transformed tokens. The residual connection can also be applied for each transformer encoder block. Based on the fourth vectors, a decoder network generates segmentation masks of the patient's lung with high resolution and refined boundaries. The segmentation mask contains the location of one or more anatomical features, for example a lung, in the medical volumetric image dataset of, for example, a computed tomography scan of a patient. Thus, by triggering the inference of the at least one trained function a segmentation dataset locating one or more anatomical features in a medical volumetric imaging dataset of a patient is obtained.

The computer-implemented method, in some examples, may further comprise generating multiple local descriptors of the medical volumetric imaging dataset at multiple query locations, each local descriptor being indicative of voxel values of multiple voxels in a respective sampling region surrounding the respective query locations. The method may further comprise processing each local descriptor in the at least one trained function to obtain a respective local segmentation dataset for at least part of the respective region and aggregating the local segmentation datasets obtained for the multiple query locations to obtain the segmentation dataset.

A local descriptor provides imaging information around a point of interest or a query location in the medical volumetric imaging dataset. A local descriptor captures features from specific regions or points within the medical volumetric imaging dataset. A local descriptor may be implemented as a vector including voxel values of certain voxels in a neighborhood of the query location. The local descriptor encodes sufficient structural information to achieve effective matching in the target image. The spatial region around the query location may be called the sampling region.

According to various examples, the local descriptor may sparsely sample the sampling region. I.e., the local descriptor may not include each voxel within the certain sampling region but may rather include a subset of voxels within the sampling region. Sparse sampling means that, given the total number of voxels that make up the medical volumetric image in a respective neighborhood of the query location, only a fraction of the voxels is used in the sampling process. Thereby, the dimensionality of the local descriptor is reduced, further facilitating efficient processing in the training function. At the same time, by appropriately adapting the sparse sampling scheme, the relevant features may be preserved in the descriptor.

For example, the query location may be a lung nodule, and the sampling region may be the nearest neighborhood around the lung nodule having a certain predefined extent. The local descriptor is generated around the query location and passed to the one trained function, where the local descriptor is processed through ResNet, the transformer network and the decoder to generate a local segmentation dataset. This process can be repeated for each local descriptor of the image obtained by querying multiple query locations to obtain multiple local segmentation datasets of the medical volumetric imaging dataset. The multiple local segmentation datasets can be aggregated to obtain the segmentation dataset of the medical volumetric imaging dataset of the patient.

A query location can be any location in the image. The query location can be, e.g., any grid point of a query grid. For example, the image can be divided into 10 mm grid blocks of a query grid, and each grid point of the query grid can be a query location. For instance, multiple query locations may be set in accordance with a predefined scheme. For instance, query locations may be determined in accordance with a query grid. For instance, query locations may be positioned at center points of a query grid. Query locations may be positioned at centers of unit cells of a query grid.

The query grid may be a regular Cartesian grid. Also, non-Cartesian query grids may be used. For instance, query grids having adaptive grid-point densities, depending on structural information included in the medical volumetric imaging data set, may be employed. Thereby, as an alternative or in addition to the descriptors sparsely sampling, at each query point, the medical volumetric imaging data set, and additional layer of sparsity can be introduced using adaptive query grids.

According to various examples, the query grid may be used to query the medical volumetric imaging dataset at even intervals. For example, the query grid may cover the entire volumetric imaging dataset and be evenly spaced. The grid distance of the query grid defines the distance between two neighboring edges/grid lines of the query grid. For example, a 2D query grid with a grid distance of 10 mm may be used to cover a 2D slice of the medical volumetric imaging dataset. By querying, for example, each center of the query grid unit cell, local descriptors for each query location are obtained.

According to examples, the computer-implemented method may use a sparse sampling to obtain, for each of the at least one query location in the medical volumetric imaging dataset, a respective local descriptor. Each local descriptor provides a 2D array of voxel values of multiple voxels located at grid points of one or more respective sparse local descriptor sampling grids positioned based on the respective query point, wherein each first feature vector is generated by encoding a respective descriptor. Thus, in other words, for every query location, one or more respective local descriptor sampling grids are used to determine the sampling points for the descriptor.

As will be appreciated, while the query locations may be set in accordance with a query grid, additionally, the sparse sampling for determining a respective descriptor at any given query location may be, in turn, in accordance with a local descriptor sampling grid. Thus, while the query grid is at query location level, the local descriptor sampling grid is at descriptor level. Different grids may be used for querying and descriptor sampling, respectively.

The sparse sampling may use one or more sparse local descriptor sampling grids with different grid sizes and resolutions or grid spacing. The different grid sizes of the sparse local descriptor sampling grids determine the number of distributed sampling points per descriptor. For example, a 7×7×7 sparse local descriptor sampling grid has seven sampling points or sparse grid points in each dimension. The resolution or grid spacing of the sparse local descriptor sampling grid determines the distance between two respective sampling points. In other words, the different grid spacings or resolutions of the sparse local descriptor sampling grid result in different inter-sampling point distances of the distributed sampling points in the respective local descriptor. The respective grid spacing or resolution of the sparse local descriptor sampling grid is defined as the distance between two adjacent nodes of the respective sparse grid, wherein the respective node is defined as the intersection of three sparse grid lines and forms a sampling point. For example, a sparse grid with a resolution of 2 mm and a grid size of 7×7×7 has seven sampling points in each dimension and each sampling point is 2 mm apart from each other. The grid size and the resolution of the sparse local descriptor sampling grids may determine the sampling region of the respective descriptor at the respective query location.

According to various examples, the sparse sampling uses a plurality of sparse local descriptor sampling grids, for example, 2D and/or 3D sparse local descriptor sampling grids with different grid sizes and/or different resolutions. For example, a high-resolution sparse local descriptor sampling grid with a grid size of 8×8×8 and a 2 mm resolution and a low-resolution sparse local descriptor sampling grid with a grid size of 5×5 and a resolution of 10 mm can be used. By forming descriptors using multiple sparse local descriptor sampling grids preferably of different dimensionality and/or different resolution (e.g., a coarse grid and a fine grid), the descriptors—albeit being obtained from sparsely sampling the medical volumetric imaging data set—can capture meaningful features of different dimensionalities and/or different resolutions. For instance, relatively large-scale features are better captured by relatively low-resolution sparse local descriptor sampling grids while small features are best captured by relatively high-resolution sparse local descriptor sampling grids. At the same time, since fine features tend to be localized, i.e., tend to have relatively limited overall extents if compared to coarse features, the number of grid points may be approximately the same for the sparse local descriptor sampling grids having high-resolution and low resolution.

The sparse sampling can use a coarse sparse local descriptor sampling grid defining multiple coarse grid points and multiple fine sparse local descriptor sampling grids centered at two or more of the coarse grid points. For example, the 7×7×7 coarse sparse local descriptor sampling grid with a resolution of 64 mm may include 7 coarse grid points in three dimensions. At each of the coarse grid points, for example, a respective 5×5×5 fine sparse local descriptor sampling grid with a resolution of 3 mm and 5 mm may be centered. The coarse sparse local descriptor sampling grid and/or the fine sparse local descriptor sampling grid can be a 2D grid and/or a 3D grid with different grid sizes and grid spacings. As a result, the sparse sampling can follow a hierarchical sparse sampling strategy and hierarchical information is obtained. Such multi-hierarchy descriptor sapling can effectively capture coarse and fine features even if these fine features are offset from the query location but within the respective sampling region.

The one or more predefined sparse local descriptor sampling grids can comprise multiple 3D sparse local descriptor sampling grid at multiple grid sizes. For example, the sparse local descriptor sampling grids can include a 3D sparse local descriptor sampling grid at a 9×9×9 grid size and another sparse local descriptor sampling grid at a 7×7×7 grid size. This has the effect of increasing the granularity of the sparse sampling.

According to examples, three 2D sparse local descriptor sampling grid with three 27×27 orthogonal planes at 4 mm resolution may be used.

For instance, six 3D 9×9×9 sparse local descriptor sampling grid at multiple resolutions of 2, 3, 5, 12, 28, and 64 mm may be used, from coarse to fine. This results in a 9×9×9×9 dimensional local descriptor. The local descriptor is obtained, for example, by querying the center of a query grid. In this way, the descriptor contains information about the voxels around the query point from both local and global regions.

According to examples, all sampling regions of the multiple query locations taken together sample at least 50% of a field of view of the medical volumetric imaging dataset, optionally at least 80%.

Thus, essentially the entire medical volumetric imaging data set is sampled. This may enable whole-body multi-organ segmentation across the entire medical volumetric imaging data set. Such extensive processing across substantially the entire field of view of the medical volumetric imaging data set is facilitated by the sparse sampling, e.g., at the level of the query grid and/or at the level of the descriptors. This reduces the computational burden required in order to process such large amounts of data in the trained function.

According to various examples, the sampling regions of nearest-neighbor query locations can be non-overlapping or partially overlapping. For instance, when using overlapping sampling regions associated with nearest-neighbor query locations, it becomes possible to use advanced logic when merging respective segmentation data sets output by the at least one trained function. For instance, overlaps between segmentation masks may be calculated. Duplicates may be removed. It may be determined whether certain segmented objects pertain to the same organ/instance or segment distinct instances. On the other hand, by using overlapping sampling regions, the computational resources required for processing the medical volumetric imaging data sets increase because certain regions in the field of view of the medical volumetric imaging data sets are processed at least twice.

The at least one trained function comprises an encoder network comprising multiple 2D convolutional layers. The convolutional layers reduce the dimension of the local descriptors. For example, the local descriptor obtained by the sparse sampling method of the sparse sampling may be a 2D array of voxel values. For example, the 2D local descriptor is processed by the convolutional layers to generate a first feature vector of only a single dimension. The one-dimensional first feature vector is then processed further by the trained function.

According to examples, the transformer network of the computer-implemented method is a residual transformer network comprising multiple multi-headed self-attention layers and skip-connections across two or more of the multi-headed self-attention layers. The skip-connections allow the network to skip layers that do not contribute to better results. Further, the skip-connections stabilize the training process by avoiding vanishing gradients.

According to examples, the trained function is trained on generated descriptors. For example, one can use several medical volumetric imaging datasets and divide them into training and test datasets containing several images with different organ classes. The generated descriptors are assembled from random locations both globally and from each organ class to achieve balanced sampling. The segmentation label can be derived from the 5×5×5 local sparse local descriptor sampling grid of the center voxel of the mask. For example, multiple descriptors can be used per training image, with 10% sourced from the balanced set. For example, a random test subset containing one hundred test subjects can be selected to generate evenly sampled descriptors to evaluate the segmentation performance of the whole medical volumetric imaging dataset of a patient. Once the function is successfully trained, the medical volumetric imaging dataset can be queried systematically at even intervals of, for example, a 10 mm query grid to reconstruct the segmentation of the whole volumetric imaging dataset of the patient. Compared to an organ classifier that needs to query every location in the image or utilizing edge refinement, the trained function could return voxel-wise segmentation labels in the 10 mm query grid block, providing high-resolution segmentation predictions within a single query in real time. As a result, the trained function is capable of capturing the spatial dependencies among the descriptors and provides high resolution images with refined boundaries and clear edges.

According to examples, the medical volumetric imaging dataset is a whole-body volumetric imaging dataset, wherein the segmentation dataset is obtained for at least 80% of the whole-body volumetric imaging dataset and locates multiple organs of the patient.

According to examples the trained function comprises multiple modules that are trained end-to-end.

The proposed computer-implemented method is capable of successfully reconstructing meaningful whole-volume segmentation results with high accuracy and is less time consuming than the start-of-the-art solutions, despite being trained using only random sparse samples, with fine edge details and clear organ boundaries.

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any computer system, circuit or other electrical device disclosed herein may include any number of microcontrollers, a graphics processor unit (GPU), a tensor processing unit (TPU), integrated circuits such as application-specific integrated circuits or field-programmable gate array (FPGA) circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. A computer or computing system may comprise at least one memory device and one or more computer processors that load program code from the at least one memory device and execute the program code to perform operation(s) disclosed herein. In addition, any one or more of the electrical devices may be configured to execute a program code or instructions executable by machine that is embodied in a non-transitory computer readable medium programmed to perform any number of the functions as disclosed.

In the following, embodiments will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

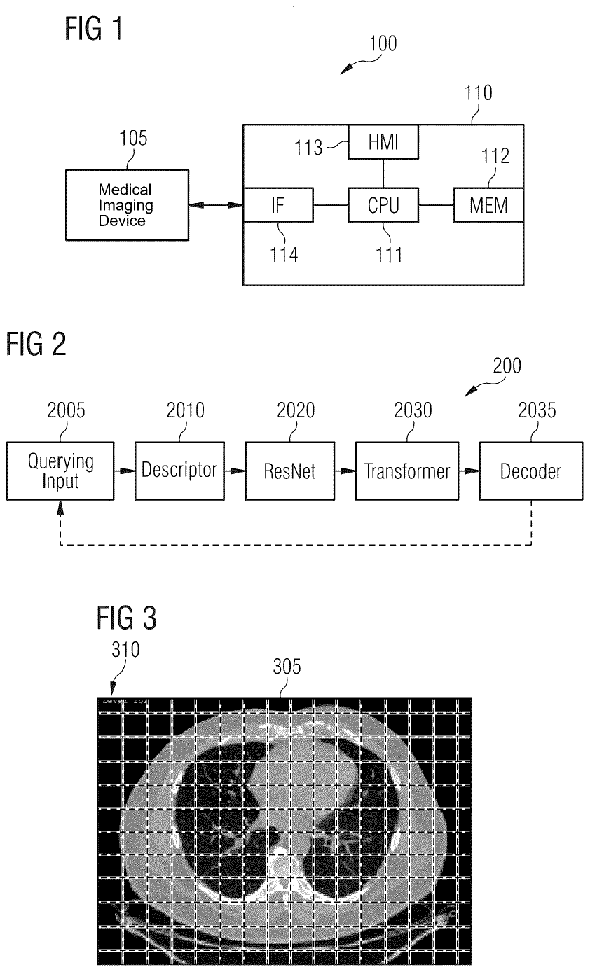

FIG. 1 illustrates a system 100 according to various examples. The system 100 comprises a medical imaging device 105 and a computing device 110. The medical imaging device 105 may be, for example, a magnetic resonance imaging scanner or computed tomography scanner. The medical imaging device 105 may perform a scan of a patient to obtain a medical volumetric imaging dataset of the patient. The medical volumetric imaging dataset depicts anatomical features, for example, a lung, heart, or any other organ of the patient. The medical volumetric dataset may be labelled 3D image of the patient.

The medical imaging device 105 is connected to the computing device 110. The computing device 110 includes a processor 111 and the memory 112. The computing device 110 further includes a human machine interface (HMI) 113 and the communication interface 114. The medical volumetric imaging dataset of the medical imaging device 105 can be visualized via the HMI 113. The processor 111 can load program code that is stored in the memory 112. The processor 111, upon loading and executing the program code, can perform techniques as disclosed herein, for example, using a trained function or to obtain a segmentation dataset. The segmentation dataset can be visualized via the HMI 113. The processor 111 can communicate with the medical imaging device 105 via the communication interface 114 to obtain the medical volumetric imaging dataset of the patient. For this, the processor 111 may provide control instructions to the medical imaging device 105 to trigger image acquisition. The processor 111 may then obtain the medical volumetric imaging data set from the medical imaging device 105. As a general rule, the processor 111 may not only obtain the medical volumetric imaging data set from the medical imaging device 105, but may alternatively load the medical volumetric imaging data set from a picture archive or another imaging database.

FIG. 2 illustrates a process pipeline 200 according to various examples.

At box 2005 the input, for example a volumetric imaging dataset of a patient, is queried at a specific query location. Note that this querying may be repeated multiple times for multiple query locations (dashed loop in FIG. 2).

The local area surrounding a given query location defines a respective local window/sampling region for which a respective segmentation dataset is obtained.

According to examples, a 2D slice of the volumetric imaging dataset can be covered by a 2D query grid. For example, in FIG. 3, 310 shows a query location of an image 305 that is covered by a 2D query grid. In various examples, every unit cell center of the query grid may be queried to obtain a local segmentation dataset for every unit cell of the query grid. Alternatively, every grid position of the query grid may form a query location.

While FIG. 3 illustrates a specific implementation of the query grid, as a general rule, in the various disclosed examples, the query grid can have different grid spacings. For example, the query grid can have a grid spacing of 5, 10, 15 mm. The query grid can be a 2D grid as shown in FIG. 3 or a 3D grid. The query grid can be evenly spaced or have a variable grid spacing. For instance, a structure-aware variable grid spacing may be used, to introduce sampling sparsity at the query level.

Referring again to FIG. 2: at box 2010, a descriptor is determined for the respective query location. Here, sparse sampling is employed. This means that a respective sampling region associated with the respective query location is sparsely sampled. For this, one or more sparse local descriptor sampling grids may be employed. The local descriptor is indicative of voxel values in a respective sampling region surrounding the respective query location. The local descriptor may provide a 2D array of voxel values of multiple voxels located at the grid points of one or more sparse local descriptor sampling grids.

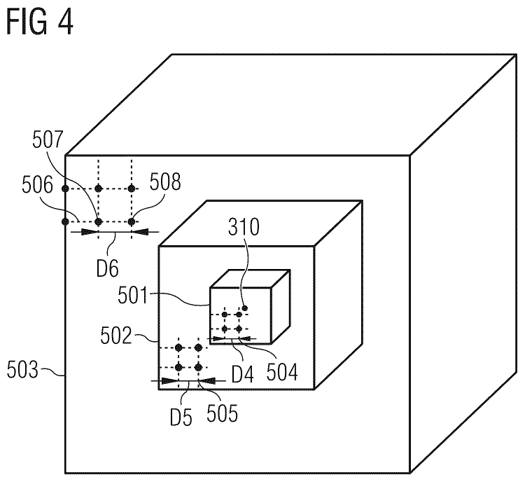

At each query location, at least one sparse local descriptor sampling grid defines the respective sampling region of the respective query location, as shown in FIG. 4. FIG. 4 illustrates three 3D sparse local descriptor sampling grids 504, 505, 506 having different grid spacings. Thus, as shown in FIG. 4, sparse sampling defines a plurality of sparse local descriptor sampling grids 504, 505, 506 of different grid spacings, the different grid spacings determining different distances D4, D5, D6 of the sampling points 507, 506 in the medical volumetric imaging dataset. With continued reference to FIG. 4, the cubes (or cuboids) are denoted with reference numerals 501, 502 and 503. The cubes 501, 502 and 503 are nested within each other, with the smallest cube 501 containing, for example at its center, the query location 310. Each cube contains a respective sparse local descriptor sampling grid, respectively. The cube 501 contains a sparse local descriptor sampling grid 504, the cube 502 a sparse local descriptor sampling grid 505 and the cube 503 a sparse local descriptor sampling grid 506. The sparse local descriptor sampling grids 504, 505, 506 may have a regular spacing; they may be Cartesian grids. For illustrative purposes, the sparse local descriptor sampling grids 504, 505, 506 are only shown in two dimensions (i.e., in the plane of the paper) and only partially. The sparse grid spacing is defined as the distance between two adjacent grid points of the respective sparse grid. Any grid point is defined as the intersection of three sparse grid lines. As shown in more detail for sparse local descriptor sampling grids 506, two grid points 507, 508 are a distance D6 apart. Similarly, the sparse grid spacing of the sparse local descriptor sampling grids 504 is defined by a distance D4, and the grid spacing of the sparse local descriptor sampling grids 505 is defined by a distance D5. The sparse local descriptor sampling grids contains one or more sampling points represented by the points 507, 508. The voxels of the medical volumetric imaging dataset may be located at the points 507, 508 and surround the query location 310.

The at least one predefined sparse local descriptor sampling grids can include, e.g., one or more 3D and/or one or more 2D sparse local descriptor sampling grids. The various sparse local descriptor sampling grids may have multiple grid sizes. For example, the grid size of the sparse local descriptor sampling grids can be 9×9×9 with resolutions of 2, 3, 5, 12, 28 and 64 mm.

For example, the sparse local descriptor sampling grids 505 can be a 2D sparse local descriptor sampling grid with a grid size of 9×9 with a resolution of 5 mm and the sparse local descriptor sampling grid 506 can be a 3D sparse local descriptor sampling grid with a grid size of 9×9×9 and a resolution of 12 mm. In another example, the sparse local descriptor sampling grid 504 can be a 3D sparse grid with a grid size of 9×9×9 and a resolution of 5 mm and sparse local descriptor sampling grids 505 can be a 3D sparse local descriptor sampling grids with a grid size of 9×9×9 and a resolution of 12 mm and the sparse local descriptor sampling grid 506 can be a 3D sparse local descriptor sampling grids with a grid size of 5×5×5 and a resolution of 28 mm.

In various examples, the at least one predefined sparse local descriptor sampling grid comprises a coarse sparse local descriptor sampling grid defining multiple coarse grid points and further comprises multiple fine grids centered at two or more of the coarse grid points. For example, a 7×7×7 coarse grid with a resolution of 64 mm may contain one or more 5×5×5 fine grids with a resolution of 5 mm. For example, each of the seven coarse grid points in one dimension of the coarse sparse local descriptor sampling grids representing a sampling point are surrounded by 5 fine grid points of the fine sparse local descriptor sampling grids also representing sampling points in one dimension. The fine grid points are centered at the coarse grid points. In another example, the 7×7×7 coarse grid with a resolution of 64 mm may contain a 5×5×5 fine grid points with a resolution of 5 mm and another 5×5×5 fine sparse local descriptor sampling grids with a resolution of 2 mm. The numbers of fine sparse local descriptor sampling grids centered at coarse sparse local descriptor sampling grid points are not limited. As a result, hierarchical information is obtained and a coarse-to-fine strategy can be utilized.

Referring again to FIG. 2: At box 2010, a local descriptor is generated at the query location or query point.

Then, for the local descriptor, a respective first feature vector is generated by encoding the respective descriptor by projecting and flattening the local descriptor. The first feature vector encodes features of the medical volumetric imaging dataset. The dimensionality of the local descriptor is reduced by the trained function. The dimensionality can be reduced, for example, by convolutional layers of the trained function. For example, the trained function may comprise an encoder network comprising multiple 2D convolutional layers to reduce the dimensionality of the local descriptor.

The first feature vector, encoding a local descriptor, is processed by a ResNet at box 2020. The ResNet fuses and extracts meaningful information from the first feature vector and outputs a second feature vector. The ResNet may contain multiple convolutional and/or linear and/or normalization layers and one or more skip-connections. The skip-connection avoids the problem of vanishing gradients and stabilizes the network. Due to the ResNet structure, the trained function can extract high-resolution features of the medical volumetric imaging dataset. A third feature vector is obtained by combining the second feature vector with positional encodings.

The third feature vector represents the input token and is processed by the transformer architecture of the trained function at box 2030. The transformer contains layers with a standard architecture of multi-head self-attention and feedforward blocks that capture the contextual information. In various examples, the transformer network is a residual transformer network comprising multiple multi-headed self-attention layers and skip connections across two or more of the multi-headed self-attention layers. The skip-connections stabilize the transformer network by avoiding vanishing gradients during training. The transformer generates a fourth feature vector. The transformer layers have the effect of capturing the spatial dependencies among the descriptors, resulting in clear edges and refined boundaries.

At box 2035, the decoder network generates a segmentation mask based on the fourth feature vector. The segmentation mask is generated within the respective sampling region associated with the current query location.

The decoder network comprises, for example, two convolutional layers to match the dimensions of the segmentation mask output. The sampling region may provide the segmentation mask of the queried sampling region with the same dimensionality as the input providing local fine details.

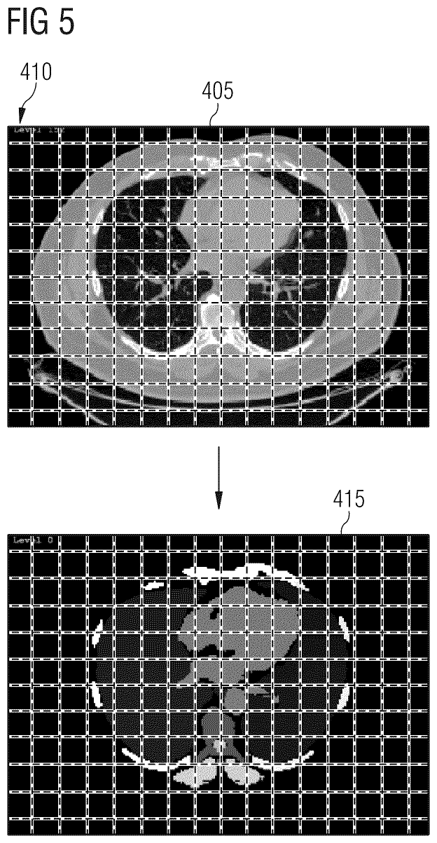

The process 200 shown in FIG. 2 may be repeated for multiple query locations (dashed arrow), resulting in a segmentation dataset locating one or more anatomical features in a medical volumetric imaging dataset of patient. For example, a query grid of 10 mm may be used and each grid center of the query grid may be queried. As a result, a segmentation mask within a sampling region of each query position is obtained. By aggregating the local segmentation dataset, a segmentation dataset for the whole image is obtained. In this way, a segmentation dataset for the entire input image is obtained. This is illustrated in FIG. 5. In particular, FIG. 5 shows an image 405 which is a horizontal slice of a computed tomography scan with a grid covering the image 405 (cf. FIG. 3). The image 415 shows the result of querying every query grid center 410 of the image 405. Respective sampling masks are shown. Multiple organs are segmented using respective sampling masks. Organ-level instance segmentation is thereby achieved.

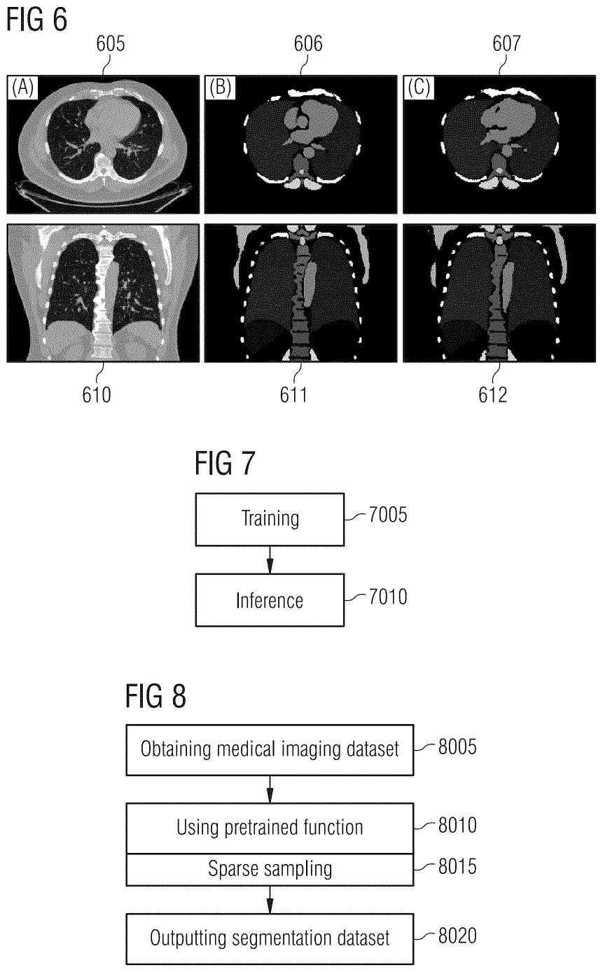

FIG. 6 illustrates segmentation datasets according to various examples. Image 605 shows a horizontal slice and image 610 shows a vertical slice of a 3D computed tomography scan of a patient. Images 606 and 611 show segmentation training samples used for training the at least one trained function. Images 607 and 612 show segmentation results from the proposed computer-implemented method. According to examples, images 605 and 610 are the input images that are queried at multiple query locations and processed according to the process pipeline 200 of FIG. 2. Images 607 and 612 are the outputs of the at least one trained function showing the segmentation dataset of a patient. The computer-implemented method is capable of successfully reconstructing meaningful whole-volume segmentation results high accuracy, fine edge details and clear organ boundaries, despite being trained using only random sparse samples.

FIG. 7 is a flowchart of a method according to various examples. The method of FIG. 7 may be executed by a computing device. More specifically, the method of FIG. 7 may be executed by a processor, upon loading and executing program code from a memory. For instance, at least part of the method of FIG. 7 may be executed by the processor 111 of the computing device 110 (cf. FIG. 1).

At box 7005, a function is trained to obtain segmentation datasets in a medical volumetric imaging dataset of a patient. For example, a training dataset of more than thousands of images obtained from a computer-tomography scan of different patients with different organ classes can be used to train the function. The training dataset can be split into a training and validation training samples. For training, descriptors that are assembled from random locations both globally and from each organ class are generated to achieve balanced sampling. Segmentation labels can be derived from a 5×5×5 local grid of the center voxel of the mask. Segmentation labels are shown, for example, in FIG. 6, where 606 and 611 are two segmentation labels. Further, one can randomly sample a thousand or more descriptors per training sample. A random validation subset containing hundreds of validation samples can be selected to generate evenly sampled sparse descriptors to evaluate the segmentation performance of the whole volume. As a result, the trained function is able to of successfully reconstruct meaningful whole-volume segmentation results with high accuracy, despite being trained using only on random sparse descriptors. On a standard consumer-grade CPU, the model achieves an average runtime of a few seconds segmenting one whole volume of a medical imaging volumetric dataset.

According to various examples, the trained function comprises multiple modules that are trained end-to-end.

At box 7010, the inference of the trained function is triggered. For inference, the trained function may be locally deployed at edge computing hardware. At box 7010, the data processing pipeline of FIG. 2 may be executed.

FIG. 8 is a flowchart of a method according to various examples. The method of FIG. 8 may be executed by a computing device. More specifically, the method of FIG. 8 may be executed by a processor, upon loading and executing program code from a memory. For instance, at least part of the method of FIG. 8 may be executed by the processor 111 of the computing device 110 (cf. FIG. 1). The method of FIG. 8 corresponds to inference of the trained function, cf. FIG. 7, box 7010.

At box 8005, a medical imaging dataset is obtained. The medical imaging dataset may be obtained from a computed tomography scan of a patient or another 3D medical imaging device (cf. FIG. 1). The medical imaging data set may be loaded from a data repository. The medical imaging dataset may contain, for example, organs of the patient or other anatomical features.

At box 8010, the pre-trained function is used for processing the medical imaging dataset obtained at box 8005.

The box 8010 contains the sub-box 8015, where sparse sampling is applied. Sparse sampling includes the generation of local descriptors for each of multiple query locations. Each local descriptor includes, e.g., one or more 2D arrays each containing voxel values of voxels surrounding the query location at a respective 2D or 3D sparse local descriptor sampling grids (cf. FIG. 4). As a result of the sparse sampling at different resolutions, the local descriptors obtain information from both global and local regions. The local descriptors obtained at the query locations through the sparse sampling are further processed by the trained function, as described in FIG. 2.

At box 8020, the pre-trained function outputs a segmentation dataset containing one or more anatomical features, e.g., as previously shown in FIG. 5 and FIG. 6. According to various examples, the medical volumetric imaging dataset is a whole-body volumetric imaging dataset, wherein the segmentation dataset is obtained for at least 80% of the whole-body volumetric imaging dataset and locates multiple organs of the patient.

For illustration, above, various examples have been disclosed that employ a query grid defining query points for which local descriptors are determined. Use of a query grid is generally optional. For instance, query points may also be randomly distributed across the field of view of the medical volumetric imaging data set.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

What is claimed is:

1. A computer-implemented method, comprising:
obtaining a segmentation dataset locating one or more anatomical features in a medical volumetric imaging dataset of a patient by using at least one trained function,
wherein the at least one trained function comprises a residual neural network processing first feature vectors encoding features of the medical volumetric imaging dataset and outputting second feature vectors,
wherein the at least one trained function further comprises a transformer network processing third feature vectors obtained by combining the second feature vectors with positional encodings and generating contextualized fourth feature vectors,
wherein the at least one trained function further comprises a decoder network for generating segmentation datasets based on the fourth feature vectors.

2. The computer-implemented method of claim 1, further comprising:
generating multiple local descriptors of the medical volumetric imaging dataset at multiple query locations, each local descriptor being indicative of voxel values of multiple voxels in a respective sampling region surrounding the respective query location;
processing each local descriptor in the at least one trained function to obtain a respective local segmentation dataset for at least parts of the respective sampling region; and
aggregating the local segmentation datasets obtained for the multiple query locations to obtain the segmentation dataset.

3. The computer-implemented method of claim 2,
wherein the sampling regions of the multiple query locations sample at least 50% of a field of view of the medical volumetric imaging dataset.

4. The computer-implemented method of claim 3,
wherein the sampling regions of the multiple query locations sample at least 80% of the field of view of the medical volumetric imaging dataset.

5. The computer-implemented method of claim 2,
wherein the sampling regions of nearest-neighbor query locations are non-overlapping or partially overlapping.

6. The computer-implemented method of claim 1, wherein the at least one trained function comprises an encoder network comprising multiple two-dimensional convolutional layers.

7. The computer-implemented method of claim 1, further comprising:
using a sparse sampling to obtain, for each of at least one query location in the medical volumetric imaging dataset, a respective local descriptor providing a two-dimensional array of voxel values of multiple voxels located at grid points of one or more predefined sparse grids positioned based on the respective query location.

8. The computer-implemented method of claim 7 wherein each first feature vector is generated by encoding a respective descriptor.

9. The computer-implemented method of claim 7,
wherein at least one predefined sparse grid comprises a coarse grid defining multiple coarse grid points and further comprises multiple fine grids centered at two or more of the coarse grid points.

10. The computer-implemented method of claim 9,
wherein the at least one predefined sparse grid comprises at least one two-dimensional predefined sparse grid and further comprise at least one three-dimensional predefined sparse grid.

11. The computer-implemented method of claim 9, wherein the at least one predefined spare grid comprises multiple three-dimensional predefined sparse grids at multiple grid sizes.

12. The computer-implemented method of claim 1, wherein the transformer network is a residual transformer network comprising multiple multi-headed self-attention layers and skip connections across two or more of the multi-headed self-attention layers.

13. The computer-implemented method of claim 1, wherein the medical volumetric imaging dataset is a whole-body volumetric imaging dataset, wherein the segmentation dataset is obtained for at least 80% of the whole-body volumetric imaging dataset and locates multiple organs of the patient.

14. The computer-implemented method of claim 1, wherein the trained function comprises multiple modules that are trained end-to-end.

15. A computer system, comprising:
at least one memory device; and
one or more computer processors that load program code from the at least one memory device and execute the program code, execution of the program code causing the one or more computer processors to:
obtain a segmentation dataset locating one or more anatomical features in a medical volumetric imaging dataset of a patient by using at least one trained function,
wherein the at least one trained function comprises a residual neural network processing first feature vectors encoding features of the medical volumetric imaging dataset and outputting second feature vectors,
wherein the at least one trained function further comprises a transformer network processing third feature vectors obtained by combining the second feature vectors with positional encodings and generating contextualized fourth feature vectors,
wherein the at least one trained function further comprises a decoder network for generating segmentation datasets based on the fourth feature vectors.

16. The computer system of claim 15, wherein the execution of the program code causes the one or more computer processors to
generate multiple local descriptors of the medical volumetric imaging dataset at multiple query locations, each local descriptor being indicative of voxel values of multiple voxels in a respective sampling region surrounding the respective query location,
process each local descriptor in the at least one trained function to obtain a respective local segmentation dataset for at least parts of the respective sampling region, and
aggregate the local segmentation datasets obtained for the multiple query locations to obtain the segmentation dataset.

17. The computer system of claim 16,
wherein the sampling regions of the multiple query locations sample at least 50% of a field of view of the medical volumetric imaging dataset.

18. The computer system of claim 16,
wherein the sampling regions of nearest-neighbor query locations are non-overlapping or partially overlapping.

19. The computer system of claim 15, wherein the execution of the program code causes the one or more computer processors to
use a sparse sampling to obtain, for each of at least one query location in the medical volumetric imaging dataset, a respective local descriptor providing a two-dimensional array of voxel values of multiple voxels located at grid points of one or more predefined sparse grids positioned based on the respective query location.

20. One or more non-transitory computer-readable media embodying instructions executable by machine to perform operations comprising:
obtaining a segmentation dataset locating one or more anatomical features in a medical volumetric imaging dataset of a patient by using at least one trained function,
wherein the at least one trained function comprises a residual neural network processing first feature vectors encoding features of the medical volumetric imaging dataset and outputting second feature vectors,
wherein the at least one trained function further comprises a transformer network processing third feature vectors obtained by combining the second feature vectors with positional encodings and generating contextualized fourth feature vectors,
wherein the at least one trained function further comprises a decoder network for generating segmentation datasets based on the fourth feature vectors.
